(19) United States
(12) Patent Application Publication
(10) Pub. No.: US 2022/0143913 A1
(43) Pub. Date: May 12, 2022

(54) METHODS TO PRODUCE LOW-DEFECT COMPOSITE FILAMENTS FOR ADDITIVE MANUFACTURING PROCESSES

(71) Applicants: UNIVERSITY OF SOUTH CAROLINA, COLUMBIA, SC (US); TIGHITCO, INC., NORTH CHARLESTON, SC (US)

(72) Inventors: WOUT DE BACKER, COLUMBIA, SC (US); MICHAEL VAN TOOREN, ELGIN, SC (US); ARTURS BERGS, CAYCE, SC (US)

(21) Appl. No.: 17/438,013

(22) PCT Filed: Mar. 11, 2020
(86) PCT No.: PCT/US2020/022037

§ 371 Date: Sep. 10, 2021

Related U.S. Application Data
(60) Provisional application No. 62/816,356, filed on Mar. 11, 2019.

(51) Int. Cl. B29C 64/314; B33Y 30/00; B33Y 40/10; B29B 13/06; B29B 15/12

(52) U.S. Cl. CPC B29C 64/314; B33Y 30/00; B33Y 50/02; B29B 13/06; B29B 15/125; B33Y 40/10

(57) ABSTRACT

A composite filament for use in additive manufacturing such as fused filament fabrication is provided, along with methods of its construction, and use incorporation application of sonic energy during the composite filament during initial formation. The composite filament allows for formation of work pieces having a complicated shape that can incorporate continuous filaments in multiple directions and orientations, which can lead to the production of stronger and more useful composite structures.

### CROSS REFERENCE TO RELATED APPLICATION

This application is the US national stage entry of International Patent Application No. PCT/US2020/022037, having a filing date of Mar. 11, 2020, which claims filing benefit of United States Provisional Application Ser. No. 62/816,356, having a filing date of Mar. 11, 2019, both of which are incorporated herein by reference in entirety.

### BACKGROUND

Additive manufacturing refers to any method for forming a three-dimensional (“3D”) object in which successive layers of material are laid down according to a controlled deposition and solidification process. Differences between additive manufacturing processes and traditional manufacturing processes include the types of materials deposited and the way in which the materials are deposited and solidified. Fused filament fabrication (also commonly referred to as fused deposition modeling) can be used to extrude materials including liquids (e.g., polymeric melts or gels) and extrudable solids (e.g., clays or ceramics) to produce a layer followed by spontaneous or controlled solidification of the extrudate in the desired pattern of the structure layer. Other additive manufacturing processes deposit solids in the form of powders or thin films, followed by the application of energy and/or binders, often in a focused pattern, to join the deposited solids and form a single, solid structure having the desired shape. Generally, each layer is individually treated to solidify the deposited material prior to deposition of the succeeding layer, with each successive layer becoming adhered to the previous layer during the solidification process.

Unfortunately, while additive manufacturing technologies have become much more common and less expensive in recent years, the technology is primarily limited to formation of prototypes, as the formation materials have been limited to those that can be extruded in a relatively narrow temperature range and generally exhibit low strength characteristics. Attempts have been made to form higher strength composite structures; for instance, by combining a high crystalline polymer with a lower crystalline polymer in a fused filament fabrication. While such attempts have provided some improvement in the art, room for further improvement exists.

### SUMMARY

The present disclosure is directed to methods and systems for forming a composite filament that can be used in an additive manufacturing process. Generally, the composite filaments described herein are formed via penetration of a matrix polymer into a filament while exposed to sonic or ultrasonic vibrations or waves to thereby form a composite filament that includes a polymeric matrix that incorporates the matrix polymer at least partially surrounding the filament. By using a sonicator or a similar implement that can produce sonic vibrations, the systems, processes, and embodiments described herein can result in improved processes for producing a composite filament. For example, the vibrations can improve the penetration of a matrix polymer into a continuous filament that includes a plurality of individual fibers in a roving or tow. Methods can include exposing a continuous filament to sonic vibrations while the continuous filament is immersed in a bath containing polymer melt or a solution of a polymer or prepolymer components and/or while the continuous filament is immersed in a degassing bath that can include a polymer but may alternatively or additionally include a solvent, a curing agent, a prepolymer, a surfactant, or combinations thereof. Introducing sonic vibrations to one or more baths can reduce the time for penetration of a polymer into the continuous filament and/or produce a more homogenous product. Additionally, the sonic vibrations can reduce the presence of defects such as entrapped or entrained gas bubbles in a composite filament.

In an embodiment of the disclosure, a process for forming a composite filament can be integrated into an additive manufacturing process to produce materials formed from the composite filament. These embodiments can provide benefits for additive manufacturing process that require substantially defect free composite filaments (i.e., composite filaments that contain few or no defects). A non-limiting example of possible defects that can be avoided by use of the disclosed process includes the entrapment or entraining of gas bubbles within the composite filament, incomplete penetration of the polymer into the starting filament, or a combination thereof. These defects can affect the performance, not only of materials formed using the composite filament, but also for processes that utilize the composite filament. For example, a process for producing a 3D object can include multiple mechanical elements for moving a composite filament to a print head. The presence of defects can weaken the composite filament, making it more likely to break during the mechanical pulling or bending that may occur in such a process. Thus, embodiments of this disclosure can provide advantages for producing a composite filament (e.g., shorter process time and fewer defects), as well as for incorporating the composite filament as part of an integrated additive manufacturing process.

A method can include immersing a continuous filament (e.g., a continuous roving) in one or more baths, at least one bath containing either a dissolved polymer (or prepolymer components) and a solvent for the polymer or a polymer melt. While the continuous filament is immersed in a bath, the continuous filament and bath can be exposed to sonic vibrations. In embodiments of the disclosure, the process can include any number of baths, such as 1, 2, 3, 4, 5, 6, or greater than 6 baths. Additionally, the exposure to sonic/ultrasonic waves can occur in any combination of the baths while the continuous filament is immersed, such as 1 bath, all baths, or combinations of baths that may be in a continuous order or may be separate. In addition, the ratios of dissolved polymer to solvent in each bath may be identical or varying. In one embodiment, the solvent ratios may be increasing, whereas in another, the ratios may be decreasing as the fiber passes through sequential baths. The ratios of solvent to polymer in each bath may be in any other order. In addition, the baths may include both solution baths and polymer melt baths. For instance, a continuous polymer may initially be immersed in a first bath containing solution that includes a polymer or prepolymer (e.g., monomers or oligomers) in a solvent and then may be immersed in a second bath that contains a melt of the polymer.

In an embodiment, a matrix polymer of the composite filament can have a high glass transition temperature (T_{g}), e.g., about 150° C. or greater. The continuous filament can be immersed in a bath for a period of time (e.g., a few seconds to several minutes); for instance, as a continuous filament is pulled through the bath. During the immersion, a matrix polymer or a component thereof (e.g., polymer in the form of a melt, a dissolved polymer, or a polymer precursor) can permeate the continuous filament to form a proto-composite filament. In embodiments of the disclosure, immersing the continuous filament in the one or more baths further includes providing sonic waves; for example, using a sonicator immersed in the bath or attached to a side or a wall defining the boundaries of the bath.

In embodiments of the disclosure, following immersion, the proto-composite filament can undergo further processing to form the composite filament. As an example, solvent can be removed from the proto-composite filament by air drying, heating, or any other suitable process, leaving the polymeric matrix at least partially surrounding the continuous filament (e.g., at least partially surrounding the individual filaments of a roving) and in intimate contact in a composite filament. As another example, a curing agent can be provided to cure a component of the polymeric matrix. In some embodiments, processing the proto-composite filament can include both a drying step (by air drying or a heater) and a curing step. In some embodiments, the curing agent can be provided as part of a second bath. In certain embodiments, a curing agent can be sprayed upon the surface of the proto-composite filament.

Example curing agents can include, but are not limited to, polyhydroxy phenols and polyamines. For example, a non-limiting list of curing agents includes: 1,3-propanediamine, ethylenediamine, diethylenetriamine and triethylenetetramine, resorcinol, bisphenol A (2,2-bis(4-hydroxyphenyl))propane, and 4,4′-dihydroxybiphenyl.

In another embodiment of the disclosure, one or more of the baths may include a prepolymer and/or a polymerizing agent. Example prepolymers can include a monomer or a mixture of monomers in solution. For example, poly(ethersulfone) or PES can be formed by reacting a diphenol compound or a salt thereof with bis(4-chlorophenyl)sulfone. Example polymerizing agents can be acids or bases including Lewis acids and bases and/or Bronsted acids and bases. Other polymerizing agents such as metals or chelating agents can also be used in embodiments of the disclosure.

Additional embodiments of the disclosure include additive manufacturing processes that include depositing a composite filament or a proto-composite filament on a print bed in conjunction with a formation material. For instance, a composite filament or a proto-composite filament and the formation material can be co-extruded from a print head as a composite material and deposited onto a print bed. In one particular embodiment, the formation material can be provided to the print head in the form of a second polymeric filament; for instance, a polymeric filament that can include a matrix polymer of the composite filament. In any case, the composite filament and the formation material can be located on the print bed according to a predetermined pattern as the print head and/or the print bed is moved to build a structure and form the additive manufactured product. In the embodiment of depositing a proto-composite filament on a print bed, the proto-composite filament can be subjected to additional processing, e.g., drying, heating, or application of a curing agent, following deposition of the proto-composite filament on the print bed.

### BRIEF DESCRIPTION OF THE FIGURES

A full and enabling disclosure of the present invention, including the best mode thereof to one skilled in the art, is set forth more particularly in the remainder of the specification, which includes reference to the accompanying figures, in which:

FIG. 1 illustrates an example embodiment for forming a composite filament as described herein.

FIG. 2 illustrates an example embodiment of the disclosure for providing a roving.

FIG. 3 illustrates another example embodiment for forming a composite filament as described herein.

FIG. 4 illustrates another example embodiment for forming a composite filament as described herein.

FIG. 5 illustrates a composite filament shaping system as may be incorporated in some embodiments of a system.

FIG. 6 illustrates a die for use in shaping a composite filament.

FIG. 7 illustrates an additive manufacturing method incorporating a composite filament.

FIG. 8 illustrates one embodiment of a print head as may be utilized in an additive manufacturing method.

FIG. 9 illustrates a perspective view of the print head of FIG. 7.

FIG. 10A shows a front view of an additive manufacturing process as may incorporate a composite filament.

FIG. 10B shows a side view of the exemplary system of FIG. 10A.

FIG. 10C shows a top view of the exemplary system of FIG. 10A.

Repeat use of reference characters in the present specification and drawings is intended to represent the same or analogous features or elements of the present invention.

### DETAILED DESCRIPTION

Reference now will be made to embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only and is not intended as limiting the broader aspects of the present invention, which broader aspects are embodied exemplary constructions.

A composite filament for use in additive manufacturing such as fused filament fabrication is generally provided, along with methods of its construction and use. Generally, the composite filament includes a continuous filament at least partially surrounded by a polymeric matrix. The composite filament allows for formation of work pieces having a complicated shape that can incorporate continuous filaments in multiple directions and orientations, which can lead to the production of stronger and more useful composite structures. In particular, the composite filaments can combine the strength and stiffness of continuous filaments (e.g., carbon tows) with the formation flexibility of additive manufacturing formation materials (e.g., polymers) to provide a composite filament capable of successful deposition according to an additive manufacturing process.

The composite filaments are particularly suitable for formation of structures for use in high performance environments, e.g., environments operating under high thermal, chemical, and/or mechanical stresses. Examples of encompassed products commonly found in such environments can include, without limitation, duct work, conduit, tubing, piping, channeling, hollow-chambered structures, fairings, brackets, sparse filled closed geometries, solid infill closed geometries, spacers, ribs and stiffeners, and other similar structures. As an example, the composite filaments can be used in forming thin-walled, complex-shaped reinforced parts that heretofore could only be manufactured in a complex, multi-step process.

The composite filaments can include a high-strength continuous filament in conjunction with a surrounding polymeric matrix that includes one or more matrix polymers, e.g., a high-performance polymer. In one embodiment, a matrix polymer can include a thermoplastic polymer that exhibits a high glass transition temperature. The composite filaments can be utilized to address the stiffness, strength, and environmental performance shortcomings (e.g., thermal resistance) that have been associated with forming polymeric parts according to conventional techniques and materials. Disclosed methods and materials can be particularly beneficial for reinforcing parts in any direction, including directions that are nonorthogonal to the build direction of the part. Thus, the composite filaments can provide for the formation of continuous filament-reinforced composite parts having complicated geometries and exhibiting high performance characteristics with reinforcement in any one direction, as well as multiple different directions, according to an additive manufacturing process.

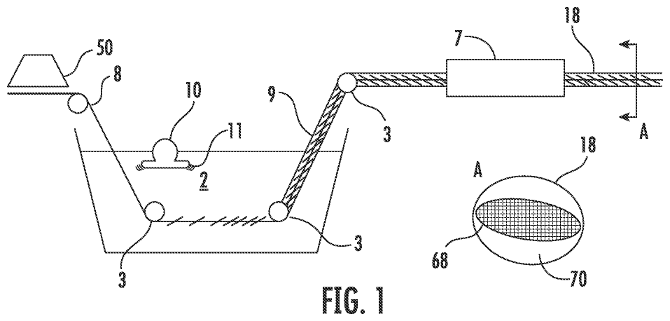

FIG. 1 schematically illustrates an example method for forming a composite filament. The method can include immersing a continuous filament 8 into a bath 2 that contains a matrix polymer or prepolymer in solution or that contains a matrix polymer melt. During immersion, the immersed portion of the continuous filament 8 can be exposed to sonic vibrations 11 generated by an implement 10 which can encourage impregnation of the continuous filament with the polymer or prepolymer components of the bath. After immersion, the impregnated filament can form a proto-composite filament 9 that can undergo additional processing such as heating to evaporate solvent or to induce reaction, e.g., polymerization reaction, with a curing agent. Upon processing, a composite filament 18 can be produced that includes a continuous filament at least partially surrounded by a polymeric matrix, the polymeric matrix including a polymer or polymerization product of the bath 2, i.e., a matrix polymer. For instance, FIG. 1 at A shows a cross-sectional view of a composite filament 18 including a plurality of individual fibers of a roving 68 at least partially surrounded by a polymeric matrix 70, the polymeric matrix including a matrix polymer of the bath 2 or a polymerization product of components of the bath 2. As indicated, a polymeric matrix 70 can surround the roving 68 as a whole and can also penetrate between individual fibers of the roving 68.

While the composite filaments 18 can be formed from any continuous filament 8 as is known in the art, in particular embodiments, a continuous filament 8 can be a high-strength, high-performance continuous filament. A high-strength continuous filament 8 can be an individual fiber (e.g., a single porous or shaped fiber that can be permeated with a polymer or prepolymer solution) or as a bundle of individual fibers, e.g., a roving.

As used herein, the term “roving” generally refers to a bundle of generally aligned individual fibers and is used interchangeably with the term “tow.” The individual fibers contained within the roving can be twisted or can be straight, and the bundle can include individual fibers twisted about one another or generally parallel continuous filaments with no intentional twist to the roving.

In some embodiments, a roving can include a plurality of a single fiber type. A single fiber type in a continuous filament 8 can be utilized to minimize any adverse impact of using fibers having a different thermal coefficient of expansion or other variations in physical characteristics between the materials of a roving.

In some embodiments, a roving can include a plurality of different fiber types. For instance, a roving can include a plurality of comingled fibers, such as mixtures of glass fibers, carbon fibers, polymer fibers, etc. In one embodiment, a roving can include individual fibers of a polymer that is included in a polymer melt in which the roving is to be immersed during formation of the composite filament. For instance, a roving can include high strength fibers, e.g., carbon fibers, glass fibers, etc., comingled with polymer fibers that include a polymer of a polymer matrix 70 of the composite filament 18, e.g., a high-performance thermoplastic polymer or a thermoset polymer, examples of which are provided below. For instance, during formation of the composite filament 18, a continuous filament 8 that is a comingled roving can be passed through a bath 2 that includes a melt of a polymer, and a polymer of the melt can be the same polymer type as is present in the polymer matrix 70 of the formed continuous filament 8.

The number of individual fibers contained in a roving can be constant or can vary from one portion of the roving to another and can depend upon the material of the fibers. A roving can include, for instance, from about 500 individual fibers to about 100,000 individual fibers, or from about 1,000 individual fibers to about 75,000 individual fibers, and in some embodiments, from about 5,000 individual fibers to about 50,000 individual fibers.

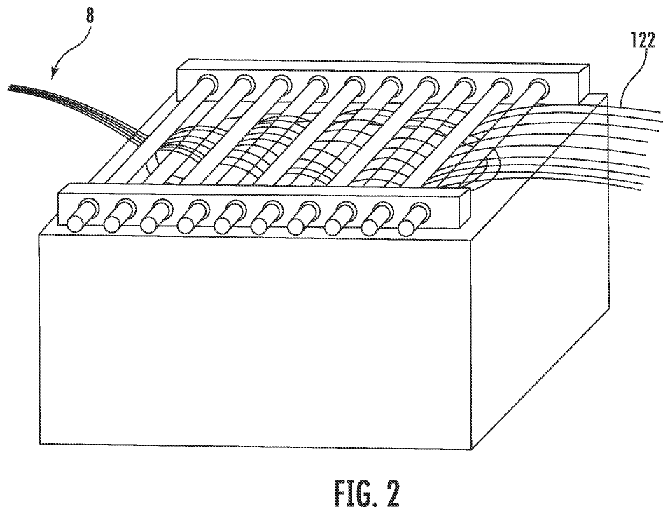

Referring now to FIG. 2, in certain embodiments, the continuous filament 8 can include a roving made of multiple individual continuous fibers 122. Embodiments of the disclosure may be of particular use or can provide benefits when applied with a roving containing high density and/or a large number of individual continuous fibers. The number of individual fibers and/or the configuration of the individual fibers may slow polymer impregnation, especially when using viscous polymers or polymer melts. For example, given a movement speed of the filament through a bath 2 (v_{f}) and a diffusion rate of polymer into the roving (d), a residence time can be determined as approximately the ratio of the two rates (τ=v_{f}/d). Using this simplification, it can be understood that increasing the diffusion rate would reduce the residence time, τ, while decreasing the diffusion rate would increase τ, thereby adjusting the time it would take to produce a length of the composite filament.

The continuous filament 8 can possess a high degree of tensile strength relative to the mass. For example, the ultimate tensile strength of a continuous filament 8 can be about 3,000 MPa or greater. For instance, the ultimate tensile strength of a continuous filament 8, as determined according to ASTM D639 (equivalent to ISO testing method 527), is typically from about 3,000 MPa to about 15,000 MPa; in some embodiments, from about 4,000 MPa to about 10,000 MPa; and in some embodiments, from about 5,000 MPa to about 6,000 MPa. Such tensile strengths may be achieved even though the continuous filament 8 is of a relatively light weight, such as a mass per unit length of from about 0.1 to about 2 grams per meter, in some embodiments, from about 0.4 to about 1.5 grams per meter. The ratio of tensile strength to mass per unit length may thus be about 2,000 Megapascals per gram per meter (“MPa/g/m”) or greater; in some embodiments, about 4,000 MPa/g/m or greater; and in some embodiments, from about 5,500 to about 30,000 MPa/g/m.

Referring again to FIG. 1, in certain embodiments, the system for producing the composite filament 18 can include one or more rollers 3 for moving a continuous filament 8 through a bath 2 and any additional associated processing components, e.g., a heater 50, a dryer 7, shaping dyes, etc. In certain implementations, the rollers 3 and/or a feeding unit that provides the composite filament 18 can include at least one sensor for measuring the tension of the continuous filament 8 or the proto-composite filament 9 as it moves through the system. Using the tension readings, the tension of the filament can be adjusted based on a feeding rate of the continuous filament 8, the movement rate of the proto-composite filament 9, and/or the exit rate of the composite filament 18.

A continuous filament 8 may include individual fibers that can be the same or different from one another and can include organic fibers (e.g., polymer fibers) and/or inorganic fibers (e.g., glass, ceramic, etc.). For example, a continuous filament 8 may include fibers composed of a metal (e.g., copper, steel, aluminum, stainless steel, etc.), basalt, glass (e.g., E-glass, A-glass, C-glass, D-glass, AR-glass, R-glass, S1-glass, S2-glass, etc.), carbon (e.g., amorphous carbon, graphitic carbon, or metal-coated carbon, etc.), nanotubes, boron, ceramics (e.g., boron, alumina, silicon carbide, silicon nitride, zirconia, etc.), aramid (e.g., Kevlar® marketed by E. I. duPont de Nemours, Wilmington, Del.), synthetic organics (e.g., polyamide, ultra-high molecular weight polyethylene, paraphenylene, terephthalamide, and polyphenylene sulfide), polybenzimidazole (PBI) filaments, and various other natural or synthetic inorganic or organic materials known for forming fibrous reinforcing compositions as well as mixtures of fiber types.

In some embodiments, the continuous filament 8 can be formed entirely of materials having a melting temperature greater than the deposition temperature of the additive manufacturing process in which the composite filaments will be used and greater than the melting temperature of a matrix polymer of the polymeric matrix 70. In some embodiments, a continuous filament 8 can include individual fibers that include a matrix polymer of the polymeric matrix 70 the composite filament 18, e.g., a matrix polymer that is also a component of the bath 2. In such an embodiment, the continuous filament 8 will also include individual fibers that have a melting temperature greater than the deposition temperature and greater than that of the polymeric matrix, e.g., carbon fibers, glass fibers, higher melt temperature polymer fibers, thermoset polymer fibers, etc. The materials used to form the continuous filament 18 can optionally include one or more various additives as are known in the art, e.g., colorants, plasticizers, etc.

Carbon filaments are suitable for use as a continuous filament 8 in one embodiment. Carbon filaments can typically have a tensile strength to mass ratio in the range of from about 5,000 to about 7,000 MPa/g/m.

The continuous filament 8 can generally have a nominal diameter of about 2 micrometers or greater; for instance, about 4 to about 35 micrometers, and in some embodiments, from about 5 to about 35 micrometers.

Referring again to FIG. 1, a continuous filament 8 can be immersed in a bath 2. In some embodiments, the bath 2 can be in the form of a solution that contains a matrix polymer dissolved in a solvent and/or prepolymer components of a matrix polymer such as monomers or oligomers dissolved in a solvent. In some embodiments, the bath 2 can be in the form of a polymer melt (also referred to herein as a melt pool) that contains in the melt a matrix polymer of the composite filament 18. In some embodiments, the continuous filament 8 can be pulled and/or pushed through the bath 2 by use of a series of rollers 3, as shown. In those embodiments in which the continuous filament 8 includes individual fibers that include a matrix polymer of the composite filament 18, the continuous filament 8 will generally not be passed through a bath 2 that includes a solution of the dissolved matrix polymer, but rather may be passed through a bath 2 that includes a melt of the matrix polymer.

In one embodiment, the continuous filament 8 can be preheated prior to immersion in a bath 2; for instance, by use of a heater 50 or the like. Preheating of a continuous filament 8 prior to immersion in a bath 2 can prevent quenching of the bath 2 and can reduce effects due to temperature difference between the continuous filament 8 and the bath 2. For instance, the continuous filament 8 can be preheated prior to immersion in a bath 2 to a temperature that is at or near the glass transition temperature of a polymer of the bath 2 (or a polymer to be formed of components of the bath 2), which is generally a matrix polymer of the composite filament 18. In some embodiments, the continuous filament 8 can be preheated to a temperature that is between the glass transition temperature of a matrix polymer of the composite filament 18 to be formed by the process and about 10° C. below this glass transition temperature.

While the composite filament 18 can generally incorporate any matrix polymer that may be successfully associated with the continuous filament 8, in one embodiment, a matrix polymer can be a high-performance thermoplastic polymer or a thermoset polymer. High-performance polymers as may be incorporated in the composite filament can include, without limitation, amorphous thermoplastics such as polysulfone (PSU), poly(ethersulfone) (PES), and polyetherimide (PEI), as well as semi-crystalline thermoplastics such as polyaryl sulfides, such as poly (phenylene sulfide) (PPS); polyaryl ether ketones (PAEK) including polyether ketones (PEK) and polyetheretherketone (PEEK); partly aromatic polyamides such as polyphthalamide (PPA); liquid-crystalline polymers (LCP); polyphenylene sulfones (PPSU); as well as blends and copolymers of thermoplastics.

In certain embodiments, a matrix polymer, rather than being dissolved in a solution as either a complete polymer or one or more prepolymer components, can be present in a bath 2 as a melt. As used herein, a polymer melt can include a polymer that is above its glass/crystallization temperature, such that the polymer melt flows freely. Polymers that can be included as a polymer melt in a bath 2 can include any polymers or combinations of polymers disclosed herein. Additionally, since the nature of polymers is variable and can include copolymers, block copolymers, and multi-mers that may have linear or branched structures made from single or multiple monomers, it should be recognized that the general term polymer is not constrained to only the specific polymers disclosed and can include variations or polymers that have yet to be synthesized. Provided herein are examples of polymers that may be used in practicing embodiments of the disclosure.

Suitable thermoset polymers as may be utilized as a matrix polymer can include, without limitation, epoxy resins, silicone resins, polyimides, phenol formaldehyde resin, diallyl phthalate, as well as combinations of materials. It will be understood by one of ordinary skill in the art that when considering formation of the composite filament to include a thermoset matrix polymer, it may be beneficial to encourage final cure of the matrix polymer following the additive manufacturing process so as to improve consolidation of the composite filament in the manufactured structure.

Referring again to FIG. 1, a continuous filament 8 can be immersed in a bath 2 containing a polymer or prepolymer dissolved in a solvent or containing a polymer melt. The immersed continuous filament 8, while in the bath 2, can be subjected to ultrasonic waves 11 emitted by an implement 10 that is in sonic communication with the bath 2. Contact of the continuous filament 8 with the sonic waves 11 can remove dissolved gases from the polymer solution and/or the wet composite filament prior to drying. In some embodiments, an implement 10 configured to produce ultrasonic waves 11 can be immersed in the bath 2. Alternatively, or additionally, an implement 10 can be attached to the side of the bath 2 or otherwise held adjacent to the bath 2 such that the implement is in sonic communication with a continuous filament 8 as it passes through the bath 2.

In embodiments of the disclosure, the ultrasonic waves 11 can be produced at a sonication frequency ranging from about 10 kHz to about 4000 kHz. In some embodiments, the sonication frequency can range from about 20 kHz to about 2000 kHz. In certain embodiments, the sonication frequency can range from about 20 kHz to about 500 kHz.

In some embodiments, an implement 10 can include an adjustable controller for varying the sonication frequency. To vary the frequency, an implement 10 can include a power regulator containing a semiconductor or other material configured to adjust the power provided to the implement 10.

In one particular embodiment, a thermoplastic matrix polymer that exhibits a high glass transition temperature (T_{g}) can be incorporated in the composite filament. For instance, a thermoplastic polymer having a glass transition temperature of about 150° C. or greater can be dissolved in a solution forming a bath 2. Exemplary high T_{g} polymers can include, without limitation, polyethyleneimine (T_{g}=215° C.), PEI (T_{g}=217° C.), polyamide-imide (T_{g}=275° C.), polyarylate (T_{g}=190° C.), PES (T_{g}=210-230° C.), polyimide (T_{g}=250-340° C.), polyphenylene (T_{g}=158-168° C.), and amorphous thermoplastic polyimide (T_{g}=247° C.). Other examples of high T_{g} polymers include those that contain one or more of the following monomers (listed along with a published T_{g} for the homopolymer): 2-vinyl naphthalene (T_{g}=151° C.), 2,4,6-trimethylstyrene (T_{g}=162° C.), 2,6-dichlorostyrene (T_{g}=167° C.), vinyl carbazole (T_{g}=227° C.), vinyl ferrocene (T_{g} =189 ° C.), acenaphthalene (T_{g}=214° C.), and methacrylic acid anhydride (T_{g}=159° C.).

A solution can include a solvent for a matrix polymer, which can encompass organic or aqueous solvents, as determined according to the characteristics of the polymer. For instance, a solution can include PEI in a solution with a suitable solvent, e.g., methanol, ethanol, or chloroform, as is known in the art. The solution can generally include the polymer in an amount of about 20 wt. % or less, about 10 wt. % or less, or about 5 wt. % or less in some embodiments. For instance, the solution can include the polymer in an amount of from about 0.3 wt. % to about 5 wt. %, or from about 0.3 wt. % to about 3 wt. % in some embodiments.

As illustrated in FIG. 1, as the continuous filament 8 is immersed in the bath 2, the continuous filament 8 can be impregnated with or otherwise associated with polymer or prepolymer constituents contained in the bath to form a wet proto-composite filament 9. Following immersion in the bath 2, the wet proto-composite filament 9 can be subjected to additional processing. For example, a proto-composite filament 9 can be dried to remove the solvent and form the composite filament 18. For instance, the wet proto-composite filament 9 can be dried through application of energy, e.g., through use of a dryer 7.

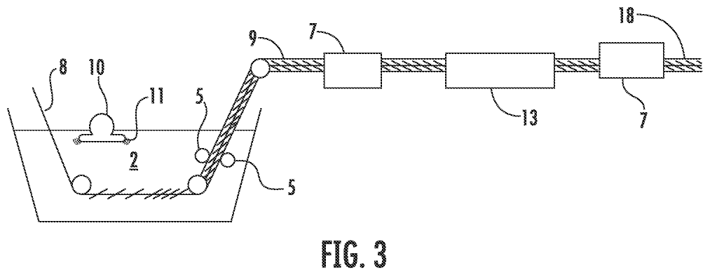

The composite filament formation process can include additional formation steps in some embodiments. For instance, as illustrated in FIG. 3, a process can include a calendaring step during which the proto-composite filament 9 can pass through a series of nip rolls 5 or the like that can improve impregnation of the matrix polymer or components thereof into the continuous filament 8.

In one embodiment, a formation process can include a die 13 through use of which a proto-composite filament 9 can be further formed or molded. For instance, either in line with initial formation or as a component of a separate system, the initially formed proto-composite filament 9 can be fed through a heated die 13 that can, e.g., incorporate additional polymer into or onto the composite polymer, mold the proto-composite filament 9, and/or modify the cross-sectional shape of the proto-composite filament 9 to, e.g., provide a particular and/or more consistent shape to the composite filament 18. Depending upon the nature of a die 13, it may prove beneficial to incorporate a second dryer 7 or the like downstream of the die 13. In one embodiment, a pultrusion system can be used to encourage motion of a nascent composite filament 18 through the system and/or one or more subsystems of a process.

Though illustrated in FIG. 1 and FIG. 3 as passing through a single bath, this is not a requirement of a process, and in other embodiments, a continuous filament 8 can pass through multiple baths, the contents of which can be the same or different from one another, one or more of which can subject the nascent composite filament to sonic energy that can be at the same or a different frequency in each bath.

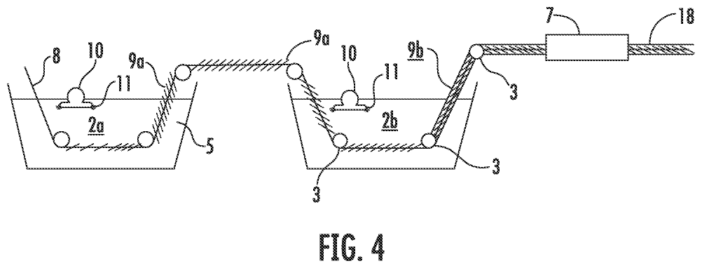

By way of example, FIG. 4 illustrates one embodiment of a system in which a continuous filament 8, e.g., a fiber roving, can be immersed in a first bath 2a. Bath 2a can contain a solution of a matrix polymer or a solution of prepolymer components of a matrix polymer or a melt of a matrix polymer. As the continuous filament 8 passes through the bath 2a, and while in sonic communication with implement 10, the continuous filament 8 can become associated with, e.g., impregnated with, matrix polymer or prepolymer components of a matrix polymer (e.g., monomers, oligomers, crosslinkers, etc.) held in the bath 2a. Following immersion, a first proto-composite filament 9a can exit the bath 2a.

Following the first bath 2a, the first proto-composite filament 9a can be immersed in a second bath 2b, which can also contain the matrix polymer or prepolymer components of the matrix polymer, either in the same form as the first bath 2a or in a second form. For example, the first bath 2a can include a solution of the matrix polymer and the second bath 2b can include a melt of the matrix polymer. In one embodiment, both baths 2a and 2b can include solutions of the matrix polymer, with the solution characteristics the same or different from one another (e.g., polymer content, solvent, etc.). Similarly, both baths 2a and 2b can include melts of the matrix polymer and can be at the same or different conditions (e.g., additives, temperatures, etc.). In other embodiments, multiple baths can carry different matrix polymers. For instance, in those embodiments in which a first matrix polymer is in close association with the continuous filaments of a composite filament and a second matrix polymer serves as a shell on a surface of a composite filament, sequential baths can differ with regard to content of matrix polymers.

As indicated in FIG. 4, a first proto-composite filament 9a can be in sonic communication with an implement 10 in a second bath 2b, and thereby subjected to sonic wavelengths during immersion in the second bath 2b. The sonic energy of a first bath 2a and that of a second bath 2b can be the same or different from one another. Moreover, not every bath of a process need include contact between the filament passing therethrough and sonic energy, and some baths can include contact with sonic energy while others may not. It will be understood by those of skill in the art that a process can include any number of immersion baths and is not intended to be limited to the use of only one or two immersion baths. Moreover, a nascent composite filament can be passed immediately from one bath to another, or alternatively, can be stored or otherwise treated prior to immersion in subsequent baths.

Processing can be carried out between individual baths in some embodiments. By way of example, a first proto-composite filament 9a can be subjected to heating, drying, polymer crosslinking, etc. prior to immersion in a second bath 2b.

FIG. 5 illustrates one embodiment of a shaping system that can be utilized to shape a composite filament 218 prior to deposition. In this particular embodiment, the shaping system can be physically separated from the initial formation system and, as such, can include an unwinder 202 that is capable of retaining and unwinding a spool of composite filament 218 that has been previously formed. Alternatively, as discussed above, a shaping system can be in line with an initial formation system. A shaping system can include a die 204 through which the composite filament 218 can pass to be shaped as desired. For instance, following initial formation, a composite filament 218 can have a noncircular cross section, such as in the form of a flat tape or the like. A die 204 can be utilized to heat and reshape the composite filament 218; for instance, to exhibit a circular cross section. Of course, any cross-sectional shape can be provided by a die including, without limitation, flat tapes, noncircular ovals, circular, square, channeled, or angled fibers (e.g., ‘U’-, ‘V’-, or ‘J’-shaped fibers), and so forth.

In some embodiments, to improve shaping of the composite filament 218, the fiber can be contacted with a lubricant 220 at or upstream of the die 204. The lubricant can generally be a polymeric material that can partially or completely surround and adhere to an external surface of a composite filament 218 and encourage the shaping of the composite filament 218 as it passes through the die 204. In one particular embodiment, the lubricant 220 can include a polymer or polymeric composition that also forms a polymeric component of the composite filament 218, e.g., an external polymeric coating. A polymeric lubricant 220 can be provided to the die 204 as a solid; for instance, in the form of a polymer tape or fiber and can be fed to the die 204 from a spool 210, for instance by use of a feeding motor 216. A polymeric lubricant 220 can provide additional benefit to a composite filament as well. For instance, the presence of the polymeric lubricant 220 on the surface of the composite filament 218 can protect the composite filament 218 during downstream processing and can prevent the buildup of noils (due to fraying or breakage of components from the composite filament) and/or excess polymer at downstream processing units.

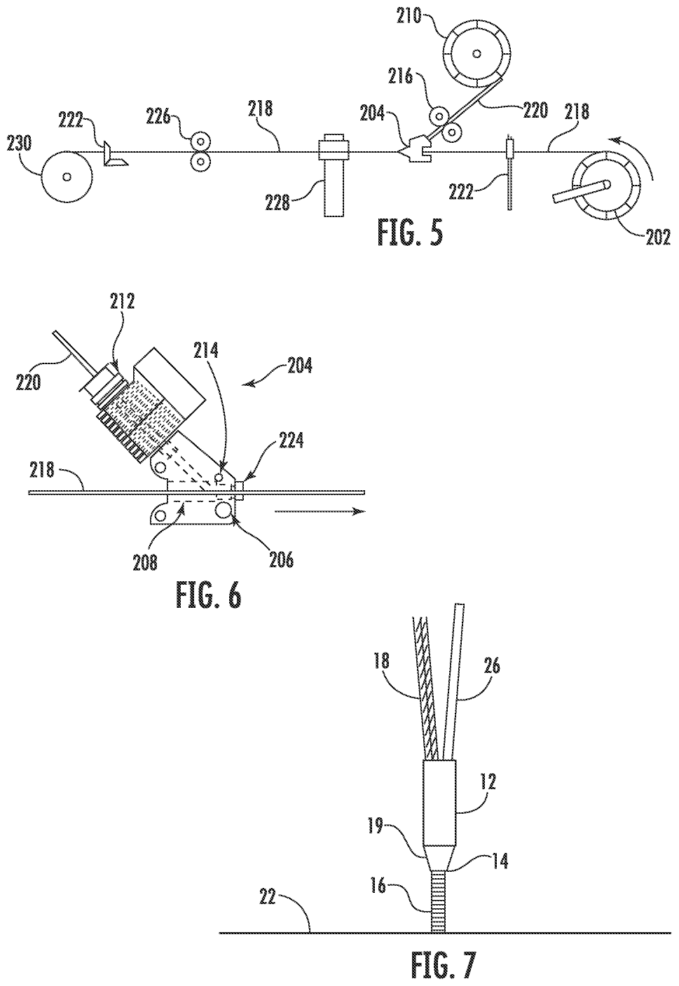

In the embodiment of FIG. 5, the lubricant 220 can contact the composite filament 218 at the die 204. For example, and as illustrated in more detail in FIG. 6, the composite filament 218 and the lubricant 220 in the form of a polymeric fiber can pass into the interior of the die 204, which can be heated; for instance, by use of a heater cartridge 206. The die 204 can be heated to a temperature suitable for melting a polymer component of the composite filament 218 and a component of the lubricant 220. Thus, the die 204 can include a melt zone 208 where the composite filament 218 and the lubricant 220 can contact one another at a temperature above the respective melting temperatures of at least one component of each. A die 204 can also include features as are standard in the art such as a heat sink, 212, thermocouples 214, etc. Following contact, the hot composite filament 218 at least partially coated with the liquid lubricant 220 can be forced through the shaping unit 224 of the die 204 so as to attain the desired cross-sectional shape prior to proceeding to further processing as indicated by the directional arrow of FIG. 6.

A shaping system can include additional components as are generally known in the art including, without limitation, guides 222, cleaning units 228 (e.g., brushes or rinsing units), sensors 226, and so forth. For instance, in one embodiment, a die can include coatings that can reduce or modify the flow of the material therethrough, e.g., can modify the friction between the material and the die surface. Such coatings are known in the art and can include, for example and without limitation, tungsten disulfate, and the like. In those embodiments in which the shaping system is held separately from the deposition system, the shaping system can also include a take-up reel 230, which can collect and store the shaped composite filament 218 for further use. A take-up reel 230 can also provide tension for pulling the composite filament 218 through the shaping system, in some embodiments.

FIG. 7 illustrates one embodiment of an additive manufacturing process as may be utilized to form a structure incorporating a composite filament. As shown, a composite filament 18 can be combined with a formation material 26. In this embodiment, the formation material 26 can be provided to a print head 12 in the form of a second filament. For instance, the formation material 26 can be a polymeric material that is fed to the print head 12 and is heated above the softening or melting temperature of the formation material 26 to soften and/or liquefy so that it can be combined with the composite filament 18 within the print head 12. The composite filament 18 can likewise be heated to a temperature above the melting or softening temperature of a matrix polymer of the composite filament 18. The composite filament 18 can be provided to the print head from a conveniently placed storage location; for instance, from a spool of previously formed and shaped composite filament 18 that can be mounted on an end effector of a deposition system. Upon combination of the formation material 26 with the composite filament 18 within the print head 12, the formation material 26 can blend and/or bond with a polymeric matrix of the composite filament 18, and the formation material 26 can form a partial or continuous coating on the composite filament 18 and thereby form a composite material 16. The composite material 16 thus formed that includes a combination of the composite filament 18 with a formation material 26 can pass through the extrusion tip 14 to the printing surface 22.

The formation material 26 may be formed of one material or an admixture of multiple materials. The formation material 26 can be, for example, a gel, a high viscosity liquid, or a formable solid that can be extruded in the desired pattern. Formation materials likewise can be organic or inorganic. Formation materials can include, without limitation, polymers including thermoplastic polymers or thermoset polymers (e.g., polyolefins, polystyrenes, polyvinyl chloride, elastomeric thermoplastics, polycarbonates, polyamides, etc.), eutectic metal alloy melts, clays, ceramics, silicone rubbers, and so forth. Blends of materials can also be utilized as the formation materials, e.g., polymer blends. The formation materials can include additives as are generally known in the art such as, without limitation, dyes or colorants, flow modifiers, stabilizers, nucleators, flame retardants, and so forth.

In one particular embodiment, the formation material 26 can include a matrix polymer as is utilized in the composite filament 18. For instance, the composite filament 18 can include a continuous filament and a high T_{g} thermoplastic matrix polymer, such as PEI, and the formation material 26 can likewise include PEI. This can improve blending and bonding of the materials in the print head in formation of the composite material 16.

The composite material 16 can be discharged from the print head 12 at a nozzle 19 during the formation of an individual layer of an additively manufactured product structure. Thus, the nozzle 19 can be sized and shaped as desired depending upon the particular characteristics of the composite material 16 to be discharged. In general, a nozzle 19 can have an outlet on the order of about 10 millimeters or less; for instance, about 5 millimeters or less, or from about 0.5 millimeters to about 2 millimeters in some embodiments. The shape of the nozzle 19 can also be varied. For instance, a nozzle 19 can have a more rounded radial edge as compared to previously known fused filament fabrication print heads, so as to better accommodate the composite material 16.

Any suitable method for combining a composite filament 18 and a formation material 26 can be utilized, provided that the continuous filament of the composite filament 18 is adequately incorporated with the formation material 26 following deposition. The type of bond formed between the composite filament 18 and the formation material 26 can depend upon the materials involved. For instance, a thermal bond, a chemical bond, a friction bond, an electrostatic bond, etc., as well as combinations of bond types, can be formed between the continuous filament and the matrix polymer of the composite filament 18 and between either or both of these components of the composite filament 18 and the formation material 26 in order that the components will be effectively bonded to one another. Moreover, bond formation of the materials can be combined with blending of two different materials of the formation material 26 and the composite filament 18. In some embodiments, a matrix polymer of the composite filament 18 and a polymer of the formation material 26 can be melted and mixed together at a surface of the composite filament 18 and within the print head 12 so as to combine the two.

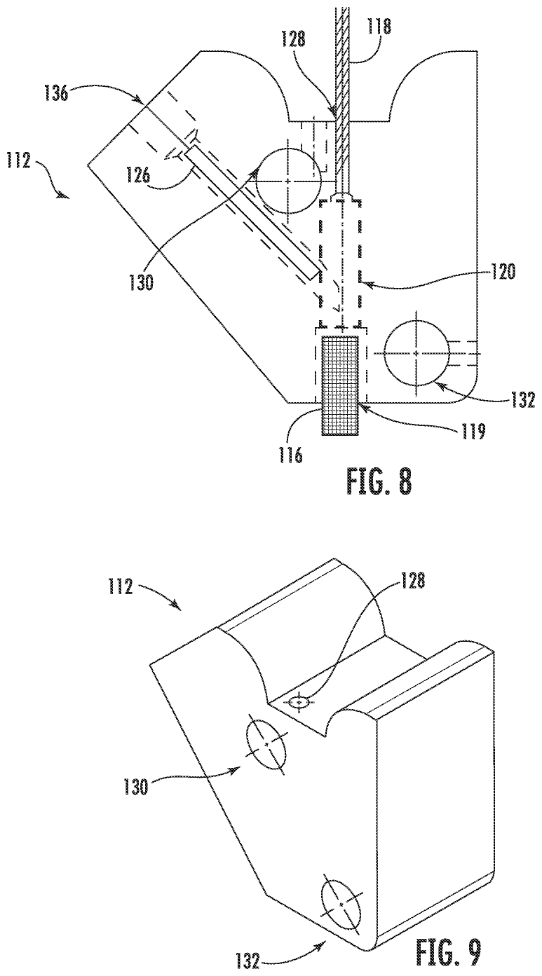

FIG. 8 and FIG. 9 illustrate one embodiment of a print head 112 for use in a system as disclosed herein that can liquefy polymers of the various materials and combine a composite filament 118 and a formation material 126 to form a composite material 116. As shown, the print head 112 includes an inlet 128 for a composite filament 118 and an inlet 136 for a formation material 126. The formation material inlet 136 can be angled with respect to the composite filament inlet 128; for instance, with an angle between the two of from about 20° to about 80°. The print head 112 can include a melt chamber 120 within which a composite filament 118 fed through the composite filament inlet 128 can be combined with the formation material 126 fed through the formation material inlet 136. The size of the print head 112, including the melt chamber 120, can be such that the print head includes an extended melt zone as compared to previously known print heads designed for fused filament formation techniques.

The relative rates of addition of the formation material 126 to the composite filament 118 can vary. For instance, the formation material 126 can be combined with the composite filament 118 within the melt chamber 120, and the flow rate of the formation material 126 through the inlet 136 can be somewhat less than the flow rate of the composite filament 118 through the inlet 128. In one embodiment, the flow rate of the formation material 126 through the print head 112 can be about 75% or less of the flow rate of the composite filament 118 through the print heat 112. In some embodiments, the flow rate of the formation material 126 through the print head 112 can be from about 20% to about 60%, or from about 22% to about 32% of the flow rate of the composite filament 118 through the print head 112. Of course, flow rates of materials are not limited to this range, and in some embodiments, it may be beneficial to feed a formation material 126 at a higher or lower feed rate as compared to the feed rate of the composite filament 118. For instance, it may be preferred to feed the formation material 126 through the print head at a higher flow rate than the composite filament 118 in some embodiments.

It may be beneficial, in some embodiments, to monitor the flow rate of components, particularly of the composite filament 118, as well as to incorporate a tension control in the system, so as to avoid filament breakage. For instance, a system can incorporate a flow rate feedback system that can provide for tension control of the composite filament tension.

To improve deposition, the various materials can be preheated prior to deposition. For instance, and as illustrated in FIG. 8 and FIG. 9, a print head 112 can include a first heater 130 that can be utilized for heating a formation material 126 fed through the inlet 136 and a composite filament 118 fed through the inlet 128 prior to their combination in the melt chamber 120. The print head 112 can optionally include a second heater 132 that can heat the combined composite material 116. The first and second heaters 130, 132 can be held at temperatures that are the same or different from one another. In one embodiment, the second heater 132 can be at a lower temperature than the first heater 130. The nozzle 119 can be heated to a nozzle temperature either via the second heater 132 or via a separate heating system for the nozzle, as desired.

In one embodiment, the formation material 126, the composite filament 118, and/or the composite material 116 can be preheated within the print head 112 or upstream of the print head and prior to deposition by use of one or more heaters to a temperature of about 360° C. or greater; for instance, from about 360° C. to about 420° C. in some embodiments. Optionally, the nozzle 119 of the print head 112 can be heated to a similar temperature, e.g., about 360° C. or greater; for instance, from about 360° C. to about 420° C. in some embodiments. The various heaters can thus provide a print temperature envelope of from about 360° C. to about 420° C. in some embodiments.

A print head may be configured to apply one or multiple coatings of formation material 126 on a composite filament 118. For instance, a deposition process can include periods of deposition of composite material in conjunction with periods of deposition of the formation material alone, which can provide additional areas of formation material adjacent to areas of the composite material. For instance, a deposition process can provide areas of composite material and areas of formation material stacked on the other, overlapping or applied at different positions on a printing surface.

Further, a print head can be configured to advance several different composite filaments in conjunction with different or the same formation materials, depending on the specifications required for formation of a work piece. In addition, a system can include multiple nozzles on a single print head and/or multiple print heads and/or multiple end effectors configured to provide either the same or different print media to a work piece, so that different compositions of materials may be used to form the work piece. For example, some print heads can be configured to either advance different composite filaments and/or formation materials to provide different composite materials to be selectively applied to the work piece. In further or alternative embodiments, some print heads may be configured to provide continuous filament reinforced composite material, while other print heads provide non-reinforced printing media to thereby provide a work piece that has selective reinforced sections.

Discharge of the composite material 116 from a print head 112 can be achieved in different manners, depending on the application. In one embodiment, the composite filament 118 may be advanced through the print head 112 as part of an extrusion process, whereby the continuous filament 118 is “pushed” or urged through the print head 112. In this embodiment, the continuous filament 118 is engaged with a driving system, such as a motorized friction drive wheel(s) or a forced air system, to advance the continuous filament 118 through the print head 112. For instance, a continuous filament 118 can enter the inlet 128 in the print head 112 and can be advanced toward the extrusion tip of the nozzle 119. The formation material 126 can be heated above the softening or melting temperature of the formation material 126, and the composite filament 118 can be heated above the melting temperature of a matrix polymer thereof to soften and/or liquefy so as to combine the two in the melt chamber 120 and thence pass through the nozzle 119. The composite material 116 can thus be advanced from the print head 112 and onto a printing surface, a mandrel, and/or an existing work piece on a print bed. By movement of the print head 112 and the printing surface relative to one another, structures can be formed by additive application of the composite material 116 onto the printing surface, mandrel, and/or existing work piece.

As an alternative to advancing the composite filament by push or urging through the print head, the composite filament and formation material may be advanced by a pultrusion operation, whereby the composite material 116 is drawn or pulled from the tip of the nozzle 119. In this embodiment, the contact point of the composite material on the printing surface of the print bed, a mandrel located on the printing surface, and/or an existing work piece located on the printing surface can create an anchor (e.g., a fixed, contact, gripping point, and the like) that allows for the composite material 116 to be pulled from the print head as the printing surface is moved relative to the print head.

Referring again to FIG. 7, drawing or “casting on” of the composite material 16 onto the printing surface 22, mandrel, and/or existing work piece to begin the printing process can be accomplished by various methods. For example, the composite material 16 can be connected or adhered to a needle or other type structure that can draw the composite material 16 from the print head and apply it to the printing surface 22, mandrel, and/or existing work piece. As an alternative, the nozzle 19 of the print head 12 may be brought into contact with the printing surface 22, the mandrel, and/or the existing work piece so as to contact the composite material 16, whereby the composite material 16 (e.g., the formation material 26 encompassed in the composite material 16) can adhere to the printing surface 22, mandrel, and/or the existing work piece creating an anchor for pulling the composite material 16 from the print head 12.

The rate of advancement of the composite material 16 through the print head 12, the temperature of the formation material 26, the matrix polymer(s) of the composite filament 18, and/or in some instances, the temperature of the printing surface 22, the mandrel, and/or the existing work piece on the print bed require some level of control to ensure that the composite material 16 is applied in a manner to provide desired adherence. For example, the temperature of the formation material 26 and the composite filament 18, and the rate of movement of the print bed and/or mandrel, may be controlled to ensure that the composite material 16 is applied in a manner to allow for proper adherence of the composite material 16 to the printing surface 22, mandrel, and/or existing work piece. In some instances, the printing surface and/or the mandrel and/or the existing work piece on which the composite material 16 is applied can also or alternatively be temperature controlled for this purpose. In general, the rate of combination and temperature of the formation material 26 on the composite filament 18 are controlled to ensure that the formation material 26 is combined in a desired manner with the composite filament 18 and that the composite material 16 is drawn from the print head 12 in a consistent manner. By way of example, a print speed for deposition of a composite material 16 onto a surface can be about 5 mm/sec or more, about 20 mm/sec or more, or about 50 mm/sec or more in some embodiments.

Tensioning of the composite material 16 may also be required for proper advancement onto the printing surface, mandrel, and/or existing work piece. Tensioning systems can take many forms and be located at different positions in the process to provide proper tensioning of the composite filament 18 and/or the composite material 16. For example, a spool maintaining the composite filament 18 can be fitted on a tensioning system, such as a rotational break or clutch, that impedes rotation of the spool as composite filament 18 is meted from the spool to provide tensioning. Similarly, the print head 12 may include a tensioning system, such as restrictive pulleys, clutch, friction element or the like, to apply tension to the composite material 16.

It is also contemplated that the printer can be equipped to perform both “push” and “pull” of the composite material 16 to advance the composite filament 18 through the print head 12. In this embodiment, there may be drive means associated with the print head 12 to advance the composite material 16 through the print head assisted by a pulling effect of the movement of the print bed, mandrel, and/or existing work piece on the composite material as it is advanced.

As mentioned above, the composite material 16 may be applied to a mandrel, where the mandrel operates as a form, support, and/or pattern of the work piece to be manufactured from the composite material 16. The mandrel aids in shaping of the work piece being printed as the composite material 16 is applied to the mandrel. After printing is complete, and the printed work piece has at least partially cured, the mandrel can be removed from the work piece, such as by eroding, dissolving, breaking, shrinking, or other contemplated procedures for removing either a portion of the mandrel or the entire mandrel.

According to one embodiment, a structure that incorporates the composite filament can be formed by use of a 3D printer that utilizes a six (6) Degrees of Freedom (or more, including seven degrees of freedom) system that allows the printing of composite material in different directions and orientations relative to a plane perpendicular of a print bed. The term “6 Degrees of Freedom” is intended to refer to the freedom of movement in three-dimensional space of the print bed onto which the filaments are printed. Specifically, the print bed has six (6) independently controllably movements: three translational movements and three rotational movements. The translational movements are up/down, left/right, and forward/backward, and the three rotational movements are typically referred to as pitch, roll, and yaw. The print head may be fixed relative to some degrees of freedom, such as up/down, or alternatively, also exhibit six degrees of freedom. In some embodiments, added degrees of freedom can be achieved by the introduction of a mandrel on the print bed to which composite material is applied. Orientation of the mandrel itself may be controlled relative to the print bed to provide added degrees of freedom (e.g., 7 degrees of freedom).

The various degrees of freedom of the print bed, and in some instances, the movement of an added mandrel, allow for complex introduction of filament(s) and/or composite materials into and/or within a work piece (e.g., object, part component, and the like) above and beyond what is achievable by a standard 3D printer. Instead of introduction of a filament and/or composite material in a stepped-fashion to a work piece, the orientation, elevation, angle, and the like of a filament(s) and/or composite material may be varied during the printing process to create complex printed formations/shapes within the work piece. For example, the filament(s) and/or composite material could be applied as the print bed is periodically or continuously altered in direction/orientation to create a complex pattern of filament(s) and/or composite material, such as for example, a zigzag pattern in the work piece or bend or complex shape in the work piece that cannot be achieved by linear application of material as performed by traditional 3D printers. The continuous filament(s) or composite material may even be twisted about itself by manipulation of the print bed and/or an alternative mandrel relative to the filament(s) or composite material during application.

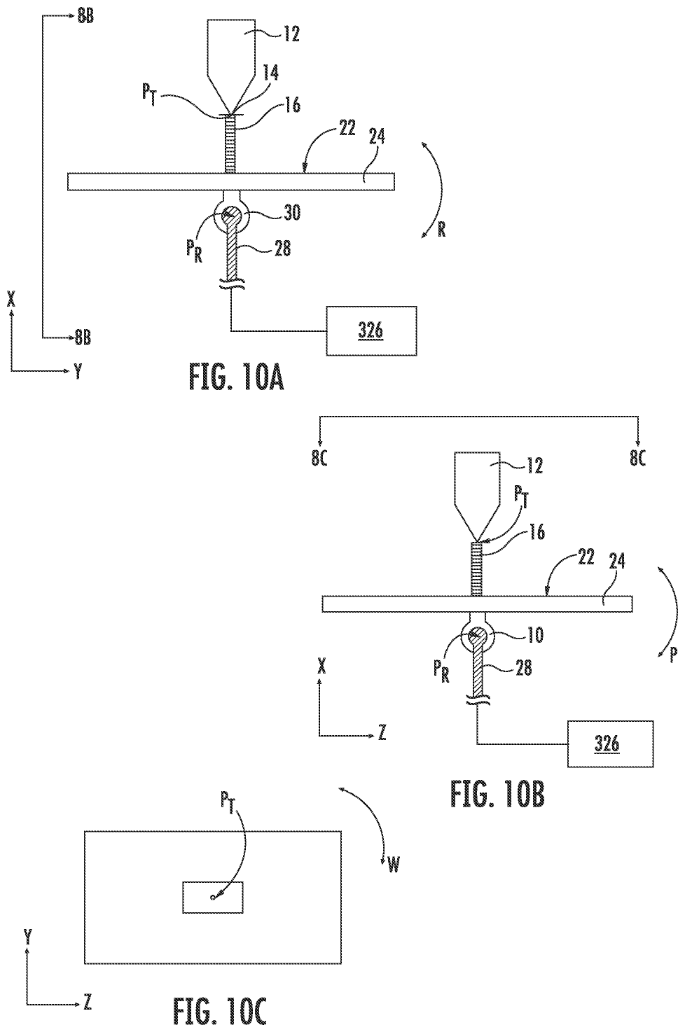

FIGS. 10A, 10B, and 10C show an exemplary system including a nozzle 12 having an extrusion tip 14 defining a translational point PT. The nozzle 12 combines a formation material 26 and a composite filament 18 to form a composite material 16 as described above and illustrated in FIG. 7. During printing, the composite material 16 is deposited onto the printing surface 22 of the print bed 24 and/or a mandrel (not shown) located on the printing surface. The print bed 24 is moveable, independently with 6 degrees of freedom, as controlled by the controller 326.

The print bed 24 is moveable in the x-direction (i.e., up/down with respect to the translational point PT), in the y-direction (i.e., laterally with respect to the translational point PT), and z-direction (i.e., cross-laterally with respect to the translational point PT). The print bed 24 can be moved translational, independently, by controller 326 using the arm 28 connected to the receiver 30 of the print bed 24. In particular embodiments, the arm 28 can be formed from multiple segments connected together at moveable joints (bending and/or rotating) to allow for translational movement of the print bed 24 with respect to the translation point PT.

Additionally, the print bed 24 is rotationally movable about the rotational point PR to allow roll (r), pitch (ρ), and yaw (w) rotational movement. The print bed 24 can be rotated in any direction, independently, by controller 326 using the arm 28 connected to the receiver 30 of the print bed 24. Although shown as utilizing a rotation ball 29 coupled to the receiver 30, any suitable connection can be utilized.

In one embodiment, the controller 326 may comprise a computer or other suitable processing unit. Thus, in several embodiments, the controller 326 may include suitable computer-readable instructions that, when implemented, configure the controller 326 to perform various functions, such as receiving, transmitting, and/or executing arm movement control signals.

A computer generally includes a processor(s) and a memory. The processor(s) can be any known processing device. Memory can include any suitable computer-readable medium or media, including, but not limited to, RAM, ROM, hard drives, flash drives, or other memory devices. The memory can be non-transitory. Memory stores information accessible by processor(s), including instructions that can be executed by processor(s). The instructions can be any set of instructions that, when executed by the processor(s), cause the processor(s) to provide desired functionality. For instance, the instructions can be software instructions rendered in a computer-readable form. When software is used, any suitable programming, scripting, or other type of language or combinations of languages may be used to implement the teachings contained herein. Alternatively, the instructions can be implemented by hard-wired logic or other circuitry, including, but not limited to, application-specific circuits. Memory can also include data that may be retrieved, manipulated, or stored by processor(s).

The computing device can include a network interface for accessing information over a network. The network can include a combination of networks, such as Wi-Fi network, LAN, WAN, the Internet, cellular network, and/or other suitable network, and can include any number of wired or wireless communication links. For instance, a computing device could communicate through a wired or wireless network with the arm 28, the rotation ball 29, and/or the nozzle 12.

In one particular embodiment, the controller 326 can include (or be in communication with a computer that includes) supporting software programs that can include, for example, computer aided design (CAD) software and additive manufacturing layering software as are known in the art. The controller 326 can operate via the software to create a three-dimensional drawing of a desired structure and/or to convert the drawing into multiple elevation layer data. For instance, the design of a three-dimensional structure can be provided to the computer utilizing commercially available CAD software. The structure design can then be sectioned into multiple layers by commercially available layering software. Each layer can have a unique shape and dimension. The layers, following formation, can reproduce the complete shape of the desired structure.

For example, the printer can be accompanied with software to slice beyond the current xyz slicing methodology used in industry. For example, 3D objects other than 3D Cartesian objects, such as an iso-parametric helically/spirally winded band around a duct, can be spirally sliced instead of sliced in a flat plane, to be able to spirally lay-down/print filament and/or slit tape/tow. Thus, the iso-parametrical slicing can be utilized with printing capability of the 6 degrees of freedom.

Numerous software programs have become available that can perform the functions. For example, AUTOLISP can be used in a slicing operation as is known in the art to convert AUTOCAD STL files into multiple layers of specific patterns/toolpaths and dimensions. CGI (Capture Geometry Inside, currently located at 15161 Technology Drive, Minneapolis, Minn.) also can provide capabilities of digitizing complete geometry of a 3D object and creating multiple-layer data files. The controller 326 can be electronically linked to mechanical drive means to actuate the mechanical drive means in response to “x,” “y,” and “z” axis drive signals and “p,” “r,” and “w” rotation signals, respectively, for each layer as received from the controller 326.

A system can include additional components as are generally known in the art that can aid in the deposition process. For instance, a system can include an accelerometer that can monitor the load on the composite filament and/or the composite material for break of the fiber during deposition. In one embodiment, a system can include auditory capability; for instance, a directed microphone that can detect scraping of the composite filament within the print head, which can detect warping and/or high tension of the filament. A print head can be utilized in conjunction with laser devices or thermal imaging cameras that can provide data with regard to the printing process, e.g., print height, cooling rate of deposited materials, etc.; a 3D scanner for real time verification of deposited geometry, etc. In addition, a system can include an active cooling mechanism for cooling the deposited material.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in-whole or in part. Furthermore, those of ordinary skill in the art will appreciate that the foregoing description is by way of example only and is not intended to limit the invention so further described in the appended claims.

1. A method for forming a composite filament comprising:
immersing a continuous filament in a bath, the bath containing a matrix polymer or a prepolymer, the matrix polymer or the prepolymer permeating the continuous filament to form a proto-composite filament;
sonicating a portion of the continuous filament as it is immersed in the bath; and
processing the proto-composite filament to form the composite filament, the composite filament comprising at least a portion of the continuous filament at least partially surrounded by a polymeric matrix comprising the matrix polymer.

2. The method of claim 1, wherein processing the proto-composite filament comprises evaporating a solvent from the proto-composite filament, curing the proto-composite filament, polymerizing the prepolymer to form the matrix polymer, subjecting the proto-composite filament to a heating source, or any combination thereof.

3. The method of claim 1, the bath containing the matrix polymer or the prepolymer in a solution.

4. The method of claim 1, the bath containing the matrix polymer in a melt.

5. The method of claim 1, wherein the continuous filament is a continuous filament roving.

6. The method of claim 5, wherein the continuous filament comprises a first portion of individual fibers and a second portion of individual fibers, the second portion of individual fibers comprising the matrix polymer.

7. The method of claim 1, wherein the matrix polymer comprises a polysulfone, a poly(ethersulfone), a polyetherimide, a polyaryl sulfide, a polyaryl ether ketone, a polyphthalamide PPA, a liquid-crystalline polymer, a polyphenylene sulfone, or a blend or copolymer thereof.

8. The method of claim 1, wherein the polymeric matrix comprises a matrix polymer having a glass transition temperature of about 150° C. to about 360° C.

9. The method of claim 1, further comprising molding the proto-composite filament to provide a predetermined cross-sectional shape to the composite filament.

10. The method of claim 9, wherein the cross-sectional shape is selected from the group consisting of: flat tapes, noncircular ovals, circular, square, channeled and angled fibers.

11. The method of claim 1, wherein sonicating the bath occurs at a sonication frequency from about 10 kHz to about 4000 kHz.

12. An additive manufacturing system comprising:
a bath configured to contain a matrix polymer or a prepolymer;
a sonicator in sonic communication with the bath;
a print head, the print head comprising a first inlet configured to receive a composite filament formed by use of the bath and the sonicator, the print head further comprising a second inlet configured to receive a formation material, the print head further comprising a heater; and
a print bed in communication with the print head.

13. The system of claim 12, further comprising a mechanical drive in communication with a controller, wherein the controller comprises a processor, a memory and a transmitter, and wherein the processor is configured to read an instruction from the memory, the transmitter is configured to send the instruction to the mechanical drive, and the mechanical drive is configured to move the print head, the print bed, or both based at least in part on the instruction along one or more of: an x-direction, a y-direction, and a z-direction, and wherein the x-direction, the y-direction, and the z-direction are substantially perpendicular.

14. The system of claim 12, wherein the sonicator produces a sonication frequency ranging from about 10 kHz to about 4000 kHz.

15. The system of claim 12, further comprising one or more of:
a first dryer downstream of the bath;
a heater upstream of the bath;
a roller, the roller configured to feed a continuous filament through the bath in formation of the composite filament;
a second dryer, wherein the second dryer is configured to heat a segment of the composite filament prior to the segment moving through the first inlet of the print head; and
a die upstream of the print head, the die comprising an opening having a cross-sectional shape configured to receive the composite filament through the opening.
